(19) United States
(12) Patent Application Publication
(10) Pub. No.: US 2026/0111208 A1
(43) Pub. Date: Apr. 23, 2026

(54) SYSTEMS AND METHODS FOR MANAGING OPERATIONS OF DATA PROCESSING SYSTEMS BASED ON POTENTIAL DESTINATIONS

(71) Applicant: Dell Products L.P., Round Rock, TX (US)

(72) Inventors: LUIS ANTONIO VALENCIA REYES, Waxahachie, TX (US); VINODKUMAR VASUDEV OTTAR, McKinney, TX (US); ABEYE TESHOME, Austin, TX (US); RICHARD M. TONRY, Georgetown, TX (US); BASSEM EL-AZZAMI, Austin, TX (US); MOHIT ARORA, Frisco, TX (US); ADOLFO SANDOR MONTERO, Pflugerville, TX (US); RAJARAVI CHANDRA KOLLARAPU, Allen, TX (US)

(21) Appl. No.: 18/919,859

(22) Filed: Oct. 18, 2024

(51) Int. Cl. G06F 8/65; H04L 9/40; H04W 4/029

(52) U.S. Cl. CPC G06F 8/65; H04L 63/107; H04W 4/029

(57) ABSTRACT

Methods and systems for managing operation of a data processing system are disclosed. To manage operation of the data processing system, policies corresponding to different potential destinations of the data processing system may be implemented using out-of-band methods. By implementing applicable policies based on the potential destination locations, update data may be identified and operation of the data processing system may be updated based on the update data prior to the data processing system traveling to the potential destination. By updating operation of the data processing system prior to traveling to the potential destination location, computer implemented services that comply with geolocation based regulations and/or limitations specified by the applicable policies may be provided.

### FIELD

Embodiments disclosed herein relate generally to managing a data processing system. More particularly, embodiments disclosed herein relate to systems and methods for managing operations of data processing systems based on policies corresponding to potential destination locations of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating a data processing system in accordance with an embodiment.

FIGS. 2A-2C show interaction diagrams in accordance with an embodiment.

FIGS. 3A-3B show flow diagrams illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware components (e.g., processors, memory modules, storage devices, communication device, etc.). The hardware components may support execution of any number and types of application (e.g., software components).

The computer implemented services may, for example, be provided based on an associated geographical location (e.g., location data) in which the data processing system is located. For example, the data processing system may be configured to operate in a certain manner based on geographical areas or regions in which the data processing system is operating.

Limitations and/or restrictions on access to and/or operation of data processing systems may be desirable by a user and/or administrator of the data processing systems. For example, an administrator of the data processing system may implement restrictions on access to and/or operation of certain functions of the data processing system by users (e.g., using customized security credentials for different users of the data processing system) in different locations. Therefore, to avoid negative consequences associated with violating policies associated with geographical locations, operation of the data processing system (e.g., and therefore the computer implemented services) may be managed based on potential destination locations in which the data processing system is traveling to.

To do so, a data processing system may include hardware resources (e.g., in-band components of the data processing system) that may transmit location data over a communication network such as a Wi-Fi network. For example, the data processing system may include a portable device, and the location data reported by the data processing system may be used to track the location of the data processing system as it is relocated over time. As the data processing system enters or exits a geographical location, operation of the data processing system may be updated (e.g., modified) based on the policy associated with the geographical location (e.g., if a policy is applicable for the geographical location).

However, the data processing system may, for various reasons, become unable to provide location data that is reliable (e.g., trustworthy, accurate, up to date, etc.). For example, hardware resources of the data processing system may become unpowered for periods of time, may be unable to connect to a communication network, and/or may become compromised by a malicious party (e.g., that may tamper with the location data). If reliable location data for the data processing system is unavailable, then the operation of the data processing system (e.g., computer-implemented services provided by the data processing system) may not be properly managed. For example, when improperly managed, the operation of the data processing system may be more susceptible to be breached or more likely to violate applicable policies (e.g., associated with certain geographical locations), which may result in inadvertent exposure of sensitive data by an unauthorized user.

In order to increase the likelihood managing the operation of data processing systems, applicable policies for the data processing system may be established and enforced using out-of-band components that verifies operations (e.g., of the data processing system) to be in compliance with the corresponding applicable policies and implements updates to operation of the data processing system based on future destination locations of the data processing system. By doing so, managing restrictions on operations of data processing systems may be implemented without utilizing an operating system of the data processing system and/or in the event that the in-band components of the data processing system are not functional (e.g., powered off, lacking network connection, etc.).

By utilizing out-of-band components of the data processing system, modifications (e.g., restrictions, limitations, etc.) to operations of hardware components of the data processing system may be managed and implemented prior to the data processing system traveling to the destination location. Therefore, decreasing the likelihood of any potential delays (e.g., due to updating operations of the data processing system) and increasing the likelihood that the desired operations of data processing system may be provided when the data processing system travels to the destination location.

By doing so, embodiments disclosed herein may provide a system for managing (operation of) a data processing system based on applicable policies corresponding to different geolocations. The applicable policies may be implemented in a seamless manner to update operations of the data processing system. Thereby, decreasing the likelihood of unrestricted access to and/or operation of the data processing system and increasing the likelihood of seamlessly implementing the applicable policies to update operations of the data processing system. Once the applicable policies are implemented (e.g., an action set to update operation of the data processing system defined by a corresponding policy), a likelihood that the data processing system may provide more desirable computer implemented services may be increased.

In an embodiment, a method for managing operation of a data processing system is provided. The method may include: obtaining, by a management controller of the data processing system and via an out-of-band communication channel, location data for the data processing system using a resource of the data processing system; identifying, by the management controller and using at least the location data, a first set of potential destination locations to which the data processing system is traveling; filtering, by the management controller and using criteria, the first set of potential destination locations to obtain filtered potential destination locations for the data processing system; identifying, by the management controller, any policies are keyed to any of the filtered potential destination locations; in an instance of the identifying where at least one policy of the any policies is keyed to at least one of the filtered potential destination locations: selecting, by the management controller, an update workflow based on the at least one policy; performing, by the management controller and using at least a sideband channel between the management controller and hardware resources of the data processing system, the update workflow to obtain an updated data processing system; and providing, using the updated data processing system, computer implemented services to a user of the updated data processing system.

The method may also include: obtaining, by the management controller and from a remote entity, the any policies, each of the any of the policies being based on a second set of potential destination locations to which the data processing system could travel in the future; obtaining, by the management controller, update data for the second set of potential destination locations; and caching, by the management controller, the update data for future use.

The method may also include discarding, by the management controller, a portion of previously cached update data based on the second set of potential destination locations, the portion of the previously cached update data being keyed to a potential destination location that is not a member of the second set of potential destination locations.

The second set of potential destination locations may be based on indicators of future intent of travel for the user of the data processing system.

The indicators of the future intent may include: personal calendar items for the user regarding the travel for the user in the future; and instant messages directed to and from the user expressing the future intent of the travel.

The indicators of the future intent may not include geolocation of the user, and geolocation of the data processing system.

Performing the update workflow may include: using a portion of the cached update data associated with the at least one policy to modify operation of hardware resources of the data processing system, the hardware resources being distinct from the management controller, wherein a second portion of the cached update data is not associated with the at least one policy and is not used to modify the operation of the hardware resources.

The data processing system may include a network module adapted to separately advertise network endpoints for the management controller and hardware resources of the data processing system, the network endpoints being usable by a server to address communications to the hardware resources using an in-band communication channel and the management controller using the out-of-band communication channel.

The management controller and the network module may be on separate power domains from the hardware resources so that the management controller and the network module may be operable while the hardware resources are inoperable.

The out-of-band communication channel may run through the network module, and the in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

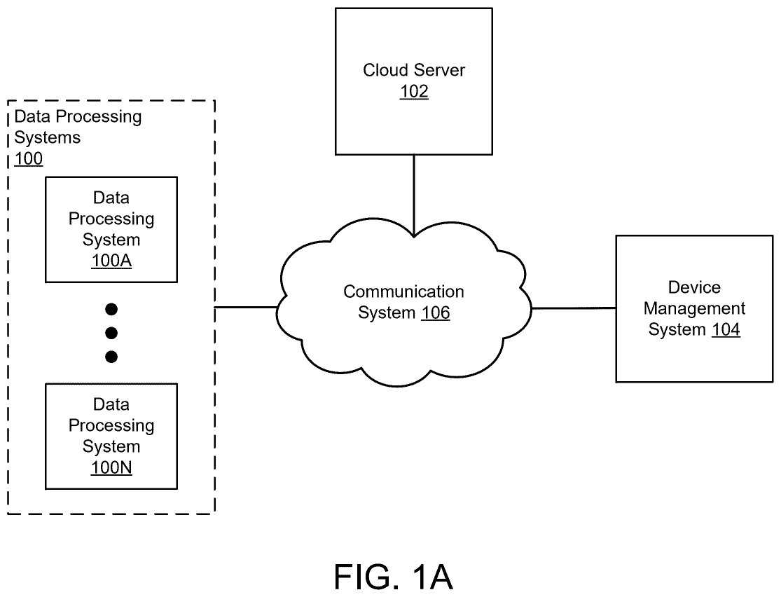

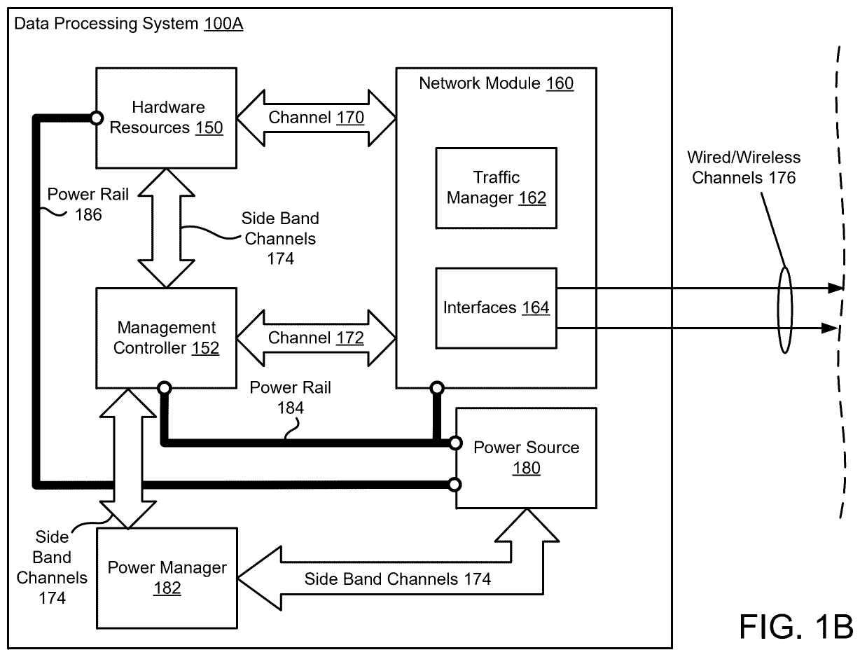

Turning to FIG. 1A, a block diagram illustrating a system in accordance with an embodiment is shown. The system shown in FIG. 1A may provide for management of data processing systems that may provide, at least in part, computer-implemented services. The system may include any number of data processing systems 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time. Refer to FIG. 1B for additional details regarding data processing system 100A.

The computer implemented services may, for example, be provided based on an associated geographical location (e.g., location data) in which the data processing system is being operated by a user. Different geographic locations in which the data processing system is located may be associated with policies that restrict certain manners of operation and/or that provide the most useful operation. The computer implemented services provided by a data processing system may only be beneficial to a user (e.g., operating a data processing system) depending on geographical areas or regions for which the data processing system is configured.

Limitations and/or restrictions on access to and/or operation of data processing systems may be desirable by a user and/or administrator of the data processing systems. For example, an administrator of the data processing system may implement restrictions on access to and/or operation of certain functions of the data processing system by users (e.g., using customized security credentials for different users of the data processing system) operating in different geographic locations. Therefore, to avoid negative consequences associated with violating policies associated with geographical locations, operation of the data processing system (e.g., and therefore the computer implemented services) may be managed based on potential destination locations in which the data processing system is traveling to.

To do so, a data processing system may include hardware resources (e.g., in-band components of the data processing system) that may transmit location data over a communication network such as a Wi-Fi network. For example, the data processing system may include a portable device, and the location data reported by the data processing system may be used to track the location of the data processing system as it is relocated over time. As the data processing system enters or exits a geographical location, operation of the data processing system may be updated (e.g., modified) based on the policy associated with the geographical location (e.g., if a policy is applicable for the geographical location).

However, the data processing system may, for various reasons, become unable to provide location data that is reliable (e.g., trustworthy, accurate, up to date, etc.). For example, hardware resources of the data processing system may become unpowered for periods of time, may be unable to connect to a communication network, and/or may become compromised by a malicious party (e.g., that may tamper with the location data). If reliable location data for the data processing system is unavailable, then the operation of the data processing system (e.g., computer-implemented services provided by the data processing system) may not be properly managed. For example, when improperly managed, the operation of the data processing system may be more susceptible to be breached or more likely to violate applicable policies (e.g., associated with certain geographical locations), which may result in inadvertent exposure of sensitive data by an unauthorized user and/or may limit the functionality of the data processing system.

In general, embodiments disclosed herein may provide methods, systems, and/or devices for managing operation of a data processing system. To manage operation of the data processing system, a system in accordance with an embodiment may utilize out-of-band components of data processing system to implement policies based on potential destination locations of the data processing system to update operation of the hardware resources of the data processing system. The data processing system may include a management controller that may communicate with other devices and/or the hardware resources without traversing in-band communication channels and without utilizing in-band components. For example, the management controller may monitor operations of the data processing system to identify indicators of future intent of travel for user of the data processing system and based on the indicators of the future intent of travel, obtain policies and corresponding update data (e.g., usable to modify operations of the hardware resources of the data processing system) for the data processing system.

By doing so, modifications to hardware resources of the data processing system may be implemented without utilizing in-band components of the data processing system, thereby decreasing the likelihood of potential issues implementing modifications to operations of the data processing system and/or increasing the likelihood of the data processing system providing desirable computer implemented services to a user in conformity with the limitations established by the polices.

Therefore, out-of-band components may be used to implement applicable policies for a data processing system (e.g., 100A) to update operation of the hardware resources hosted by data processing system 100A. To do so, location data for the data processing system may be obtained and filtered potential destination locations may be obtained based on potential destination locations identified using the location data. For example, the management controller may identify potential destination locations based on location data for the data processing system and perform a filtering process to obtain filtered potential destination locations. Based on the filtered potential destination locations, the management controller may identify any policies keyed to the filtered potential destination locations.

The identified policies (e.g., keyed to any of the filtered potential destination locations) may be utilized by the out-of-band components to select an update workflow for the data processing system to implement. The update workflow may specify an outcome and/or action sets to be performed to update operation of the hardware resources of the data processing system. By updating operation of the hardware resources (using the out-of-band components of the data processing system), an update data processing system may be obtained and utilized in order to provide computer implemented services that conform to limits specified by the policies applicable to the potential destination locations (of the data processing system).

To perform the above-mentioned functionality, the system of FIG. 1A may include data processing systems 100, cloud server 102, and/or device management system 104. Data processing systems 100, cloud server 102, and/or device management system 104, and/or any other type of devices not shown in FIG. 1A may perform all, or a portion of the computer-implemented services independently and/or cooperatively. Each of these components is discussed below.

Data processing systems 100 may include any number and/or type of data processing systems (e.g., other data processing systems, management systems, storage devices, user devices, etc.) that may provide computer implemented services, based at least in part on performing update workflows corresponding to applicable policies in order to update operation of hardware resources of the data processing system. To do so, each of data processing systems 100 may include out-of-band components (e.g., a network module, a management controller, etc.), and functionality that may allow data exchange between the out-of-band components independently from in-band components of data processing systems 100. For more information regarding out-of-band components of data processing systems 100, refer to the discussion of FIG. 1B.

For example, out-of-band components of data processing system 100A may (i) obtain, via an out-of-band communication channel, location data for the data processing system using a resource (e.g., network module and/or any other component of data processing system capable of obtaining location data using out-of-band methods) of the data processing system, (ii) identify, using at least the location data, a first set of potential destination locations to which the data processing system is traveling, (iii) filtering, using criteria, the first set of potential destination locations to obtain filtered potential destination locations for the data processing system, (iv) identifying any policies that are keyed to any of the filtered potential destination locations, (v) in an instance where at least one policy of any of the policies is keyed to at least one of the filtered potential destination locations: selecting an update workflow based on the at least one policy, performing, using at least a sideband channel between the management controller and hardware resources of the data processing system, the update workflow to obtain the updated data processing system, providing, using the updated data processing system, computer implemented services to a user of the updated data processing system, and/or (vi) performing any other processes to facilitate the desired computer implemented services.

Cloud server 102 may include any number and/or type of cloud servers that may participate in providing computer implemented services. Cloud server 102 may store and manage device registrations and/or other information related to devices authorized to establish policies associated with different potential destination locations for data processing system 100A. To perform its functionality, cloud server 102 may communicate (e.g., exchange data) with the out-of-band components of data processing system 100A using out-of-band communication channels. For example, cloud server 102 may provide control policies for data processing system 100A via a management controller of data processing system 100A (e.g., bypassing any in-band components of data processing system 100A).

To facilitate policy management services, cloud server 102 may, for example, (i) receive monitored data (e.g., any quantity and/or type of data relating to potential destination locations to which the data processing system could travel to in the future) from out-of-band components (e.g., management controller) of the data processing system and/or any other sources (e.g., remote entities, servers, and/or any other sources that may provide monitored data for the data processing system), (ii) identify potential destination locations (e.g., geographic locations) for the data processing system and/or user of the data processing system based on the monitored data, (iii) identify appliable policies based on the identified potential destination locations for the data processing system, (iv) provide the applicable policies to out-of-band components of the data processing system (e.g., the management controller of data processing system 100A), and/or (v) perform other actions that may facilitate policy management services.

To provide update data to data processing system 100A, the system may include device management system 104. Device management system 104 may include any number and/or type of device management system 104 (e.g., data processing systems, servers, storage devices, user devices, etc.) that may provide computer implemented services, such as management services. To perform its functionality, device management system 104 may communicate (e.g., exchange data) with the out-of-band components of data processing systems 100 using out-of-band communication channels. For example, device management system 104 may provide management services for data processing system 100A via a management controller of data processing system 100A (e.g., bypassing any in-band components of data processing system 100A).

To provide management services, device management system 104 may, for example, (i) receive data requests from out-of-band components (e.g., management controller of the data processing system), (ii) identify the data processing system (e.g., 100A) in which operation modifications may be requested, (iii) in response to the data requests, identify update data usable to update operations of the hardware resources hosted by the data processing system, (iv) provide the identified update data to the out-of-band components of the data processing system, and/or (v) perform any other actions to facilitate management services in order for the data processing system to provide the desired computer implemented services.

Thus, the operation of data processing systems 100 may be managed according to implementation of update workflows associated with policies identified based on potential destination locations to which data processing systems 100 may travel. The update workflows for data processing systems 100 may be implemented using out-of-band methods (e.g., using out-of-band components and via out-of-band communication channels). By doing so, modifications on the operations of data processing systems 100 (and/or hardware resources hosted by the data processing systems) may be more likely to be implemented in a seamless manner without utilizing in-band components of data processing systems 100, and/or data processing systems 100 may be more likely to provide the desired computer implemented services (e.g., that conform to limits specified by the policies applicable to the potential destination locations).

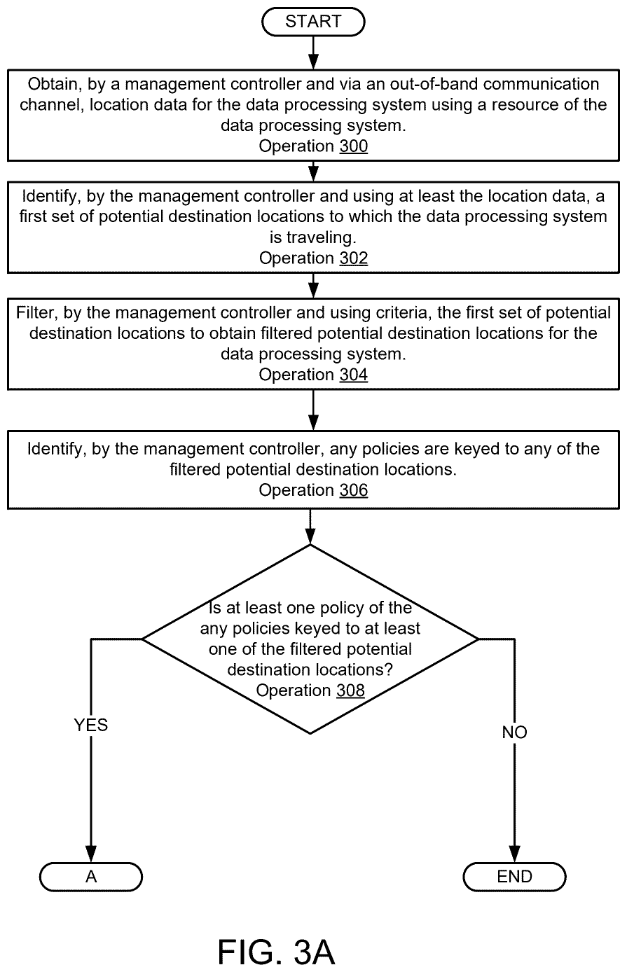

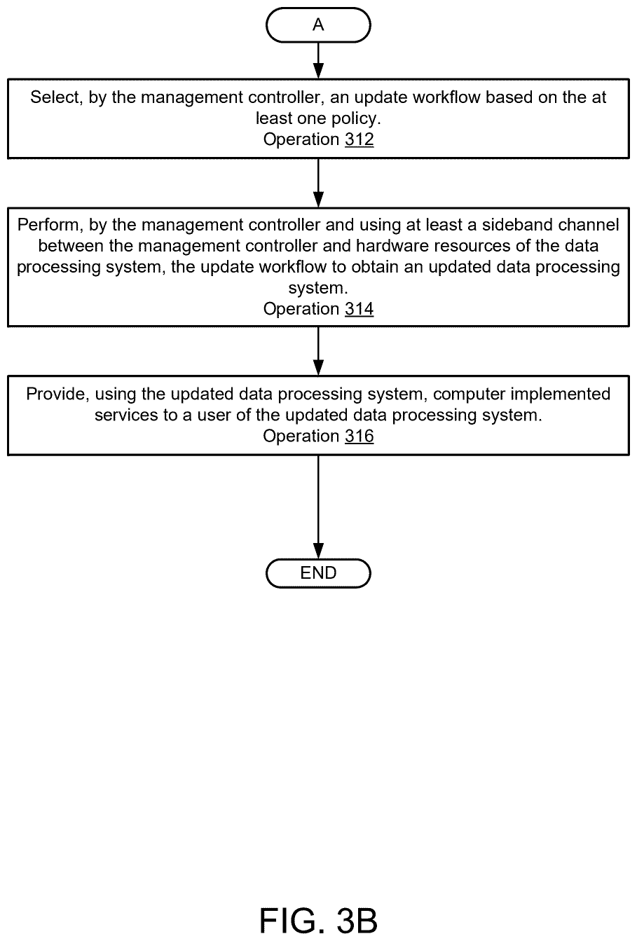

When providing their functionality, any of data processing systems 100, cloud server 102, and/or device management system 104 may perform all, or a portion of the methods shown in FIGS. 3A-3B.

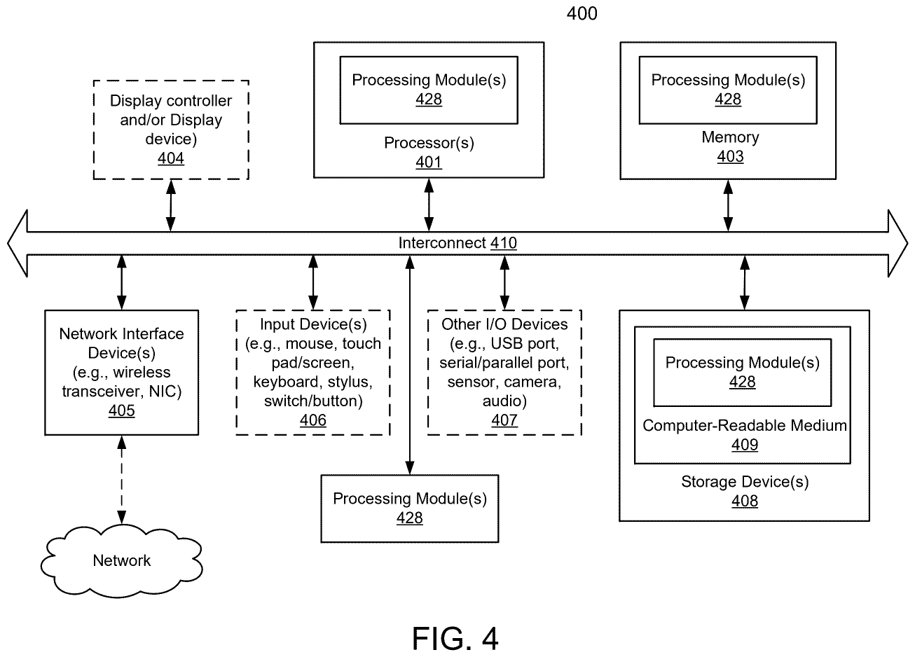

Any of (and/or components thereof) data processing systems 100, cloud server 102, and/or device management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 100, cloud server 102, and/or device management system 104 are implemented using an internet of things (IoT) device, which may include a computing device. The IoT device may operate in accordance with a communication model and/or management model known to data processing systems 100, cloud server 102, and/or device management system 104, and/or other devices.

Any of the components illustrated in FIG. 1A may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 106 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single device management system (e.g., 104), it will be appreciated that the system may include any number of device management systems.

Turning to FIG. 1B, a diagram illustrating data processing system 100A in accordance with an embodiment is shown. Data processing system 100A may be similar to any of data processing systems 100A shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100A.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100A via separate channels (e.g., 172) from the in-band components.

Management controller 152 may be implemented, for example, using a system on a chip or other type of independently operating computing device (e.g., independent from the in-band components, such as hardware resources 150, of a host data processing system 100A).

Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100A.

To facilitate communication with other devices, data processing system 100A may include network module 160. Network module 160 may provide communication services for in-band components and out-of-band components (e.g., management controller 152) of data processing system 100A.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100A via separate channels (e.g., 172) from the in-band components, and may implement or otherwise utilize a distinct and independent network stack (e.g., TCP/IP).

Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 140 over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

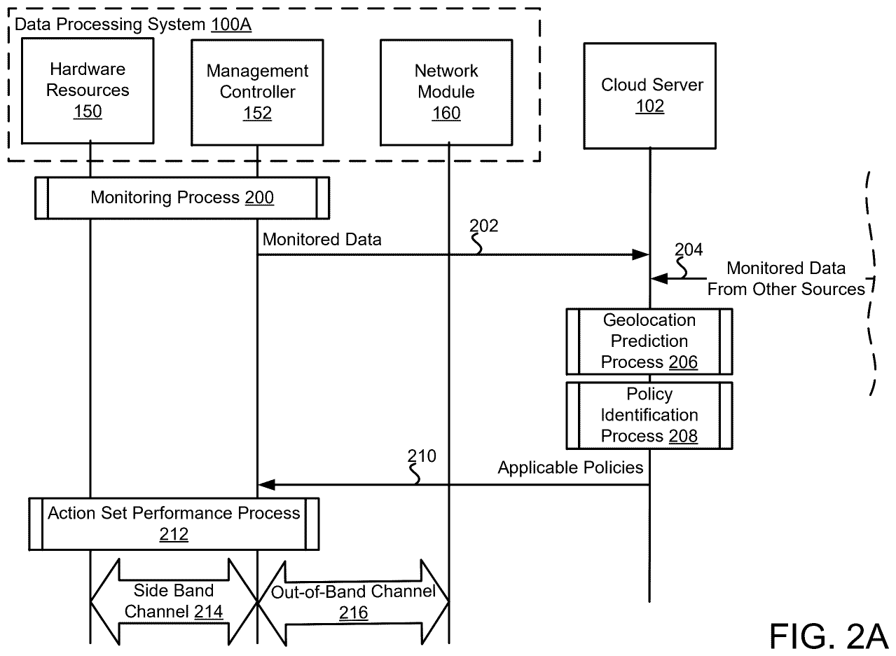

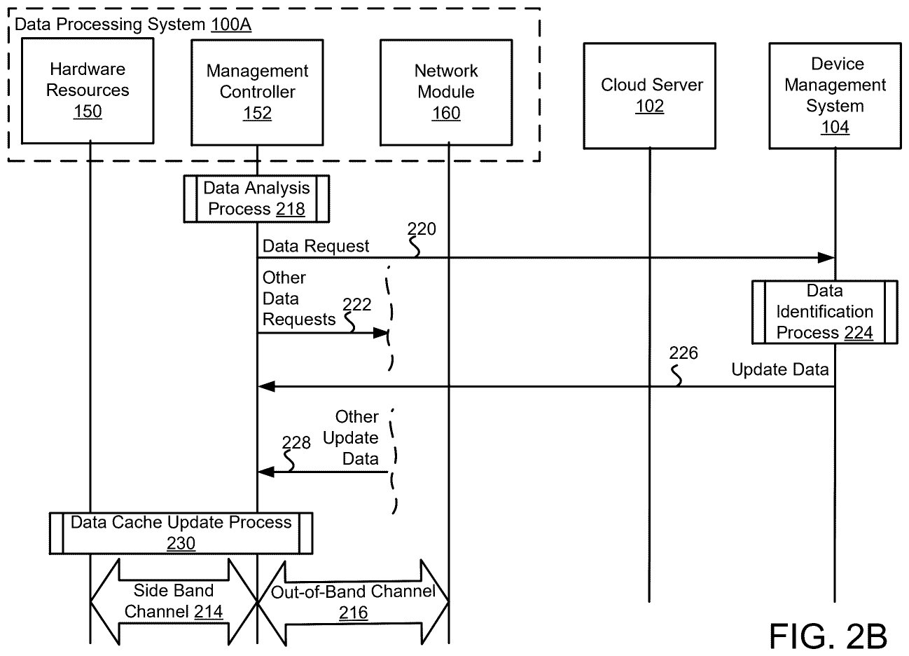

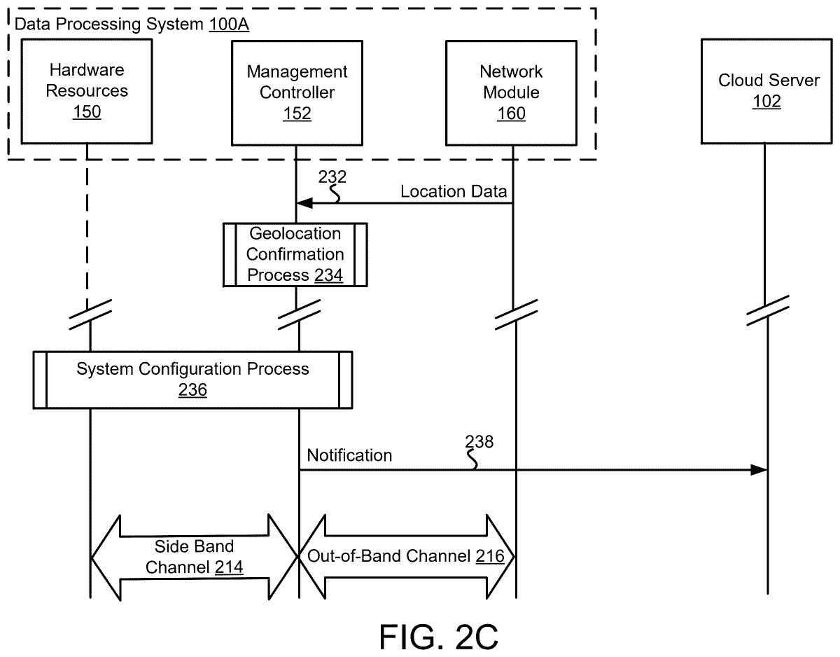

When providing its functionality, management controller 152 may perform all, or a portion, of the methods and operations described in FIGS. 2A-2C.

While illustrated in FIG. 1B with a limited number of specific components, a system may include additional, fewer, and/or different components without departing from embodiments disclosed herein.

To further clarify embodiments disclosed herein, interaction diagrams in accordance with an embodiment is shown in FIGS. 2A-2C. The interaction diagrams may illustrate examples of how data may be obtained and used within the systems of FIGS. 1A-1B.

In the interaction diagrams, processes performed by and interactions between components of a system in accordance with an embodiment are shown. In the diagrams, components of the system are illustrated using a first set of shapes (e.g., 152, 160, etc.), located towards the top of each figure. Lines descend from these shapes. Processes performed by the components of the system are illustrated using a second set of shapes (e.g., 200, 206, etc.) superimposed over these lines.

Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 210. However, it will be appreciated that the processes and interactions may be performed in different orders, any may be omitted, and other processes or interactions may be performed without departing from embodiments disclosed herein.

The processes shown in FIGS. 2A-2C may be performed by any entity shown in the systems of FIGS. 1A-1B (e.g., a device similar to one of data processing systems 100, cloud server 102, device management system 104, etc.) and/or another entity without departing from embodiments disclosed herein.

Turning to FIG. 2A, a first interaction diagram in accordance with an embodiment is shown. The first interaction diagram may illustrate processes and interactions that may occur during obtaining applicable policies based on potential destination locations for a data processing system.

To obtain the applicable policies, monitoring process 200 may be performed. During monitoring process 200, management controller 152 and hardware resources 150 may cooperatively perform any type of monitoring processes of software resources (e.g., applications, programs, etc.) hosted by data processing system 100A to obtain monitored data. Some of the monitoring processes may include analyzing data generated by applications, programs, and/or other components of the software resources of data processing system 100A to identify any indicators of a future intent to travel (e.g., to a different geolocation).

For example, hardware resources 150 may host a management controller agent (e.g., not shown) and the management controller agent may send instructions to a user's electronic mail “e-mail” application to monitor, analyze, and/or otherwise obtain any data (e.g., personal calendar items, e-mail messages, etc.) indicating travel for the user of data processing system 100A in the future. The monitored data (e.g., any type and/or quantity of data relating to activities monitored by management controller 152 and/or hardware resources 150) may be obtained as a result from performing monitoring process 200.

Once obtained, at interaction 202, the monitored data may be provided to cloud server 102 by management controller 152 via network module 160. Although not explicitly shown in FIG. 2A, it is to be understood that transmission of data, requests, etc. to and/or from management controller 152 may go through network module 160 using out-of-band channel 216. More specifically, management controller 152 may transmit data to network module 160 and network module 160 may provide the data to cloud server 102, for example, using an out-of-band communication channel (e.g., out-of-band channel 216). The out-of-band communication channel may be similar to channel 172 shown and described in FIG. 1B.

The monitored data may include any type and/or quantity of data that indicates a future intent to travel for the user of the data processing system (e.g., 100A). For example, the monitored data may include personal calendar items or appointments regarding travel plans for the user in the future, instant messages directed to and from the user expressing a future intent of travel plans, and/or any other data indicating an intent to travel in the future.

Conversely, the indicators of the future intent to travel may not include geolocation of the user and/or geolocation of the data processing system (e.g., 100A). For example, the monitored data may not be based on geographic location of the data processing system 100A and/or the user operating data processing system 100 obtained, for example, using global positioning system (GPS), cellular triangulation and/or any other methods for obtaining location of the data processing system.

In addition to obtaining monitored data from management controller 152, at interaction 204, cloud server may also obtain monitored data from other sources. For example, cloud server 102 may obtain monitored data from another source, for example, an external server (e.g., external to data processing system 100A) that generates, stores, and/or otherwise manages data for data processing system 100A. For example, a server for an email service application may provide calendar items, email messages, and/or other data containing indicators of a future intent to travel by the user of data processing system 100A to cloud server 102.

Once received, cloud server 102 may utilize the monitored data (e.g., obtained from management controller 152 and/or obtained from other sources) to perform geolocation prediction process 206. During geolocation prediction process 206, the monitored data may be subject to any type of analysis processes to identify potential destination locations of the data processing system (e.g., 100A). The analysis process may be performed by ingesting the monitored data (received from management controller 152 and/or other sources) by a prediction model (e.g., trained inference model) hosted by cloud server 102 and generating inferences indicating potential destinations based on the monitored data.

Following geolocation predication process 206, the potential destinations may be used in performing policy identification process. Policy identification process 208 may be performed to identify policies that may be applicable for the data processing system (e.g., 100A) based on the potential destination locations. For example, the potential destination locations may be used as a key to perform a look up process using a data repository of different policies to identify any applicable policies keyed to the potential destination locations. Therefore, applicable policies may be identified as a result of performing policy identification process 208.

Applicable policies may include: (i) any policies that are applicable for the data processing system based on the potential destination locations, (ii) the policies that are no longer applicable but were previously indicated as applicable, and/or (iii) any other information relating to applicable policies for the data processing system. The policies that are applicable for the data processing system may include instructions for obtaining data to update operations of hardware resources (e.g., 150) of the data processing system to comply with the corresponding policy.

For example, the policies may include different control policies that specify, for example, an outcome and/or actions (e.g., modifications) to be performed to reach a desired state for any component of the hardware resources (e.g., 150) and/or software components hosted by the hardware resources. The desired state of the hardware resources and/or software components may be a new operating state in which the hardware components and/or software resources may process data differently (e.g., relative to the current operating state). For example, the desired state of hardware resources 150 may be reconfiguring operation of applications hosted by hardware resources 150 to comply with security regulations corresponding to (any of) the potential destination locations.

Each policy may be keyed to different potential destination locations and may be established by, for example, an administrator and/or operator of the data processing system.

The applicable policies may indicate a previously applicable policy is no longer applicable and as such, the policy and/or the corresponding data may be removed and/or deleted from a storage device by the data processing system.

For example, the applicable policies may include instructions to discard a portion of previously cached update data based on the potential destination locations (e.g., identified via geolocation prediction process 206). The portion of previously cached update data may be keyed to a potential destination location that is not part of and/or one of the members of the potential destination locations identified via the geolocation prediction process 206. Refer to FIG. 2B for additional information regarding obtaining and/or caching update data for a data processing system.

Following policy identification process 208 and at interaction 210, the applicable policies may be provided to management controller 152 from cloud server 102, for example, by using an out-of-band communication channel (e.g., out-of-band channel 216). The out-of-band communication channel may be similar to channel 172 shown and described in FIG. 1B.

Following receipt of the applicable policies, management controller 152 and hardware resources 150 may cooperatively perform action set performance process 212. During action set performance process 212, management controller 152 and hardware resources 150 may perform any type of actions to comply with the applicable policies. Refer to FIG. 2B for additional details regarding performing action set processes.

Thus, as shown in the example of FIG. 2A, policies applicable to potential locations for a data processing system may be provided and established by authorized devices (e.g., cloud server 102) using out-of-band methods. By doing so, applicable policies may be provided to the data processing system without utilizing in-band components and/or without requiring functionality of the data processing system (e.g., powered on, network connection, etc.).

Turning to FIG. 2B, a second interaction diagram in accordance with an embodiment is shown. The second interaction diagram may illustrate example processes and interactions that may occur during obtainment and management of cached update data for a data processing system.

To obtain and manage the cached update data, data analysis process 218 may be performed by management controller 152. During data analysis process 218, management controller 152 may perform any type of analysis process using the applicable policies (e.g., the applicable policies 210 described above in FIG. 2A) to identify a portion of data to obtain for the data processing system (e.g., 100A). For example, management controller 152 may review the applicable policies and identify the applicable data necessary to comply with the applicable policies.

As described above, the applicable policies may include obtaining data from an external device in order to update operation of the data processing system according to the corresponding applicable policy. For example, an applicable policy may delineate a desired state of operations of the data processing system based on different geolocation locations and instructions to obtain the data necessary to update the operations of the data processing system. As a result of data analysis process 218, a data request for obtaining the data for updating operation of the data processing system may be generated.

At interaction 220, the data request may be provided to device management system 104 by management controller 152 using the out-of-band communication channel (e.g., out-of-band channel 216). Although not explicitly shown in FIG. 2B, it is to be understood that transmission of data, requests, etc. to and/or from management controller 152 may go through network module 160 using out-of-band channel 216. More specifically, at interaction 220, management controller 152 may transmit the data request to network module 160 and network module 160 may provide the data request to device management system 104, for example, using an out-of-band communication channel (e.g., out-of-band channel 216). The out-of-band communication channel may be similar to channel 172 shown and described in FIG. 1B.

In addition to providing the data request to device management system 104, at interaction 222, management controller 152 may generate and provide other data requests to other external devices. The other data requests may be provided to external devices, for example, servers and/or other computing devices that generate, store, and/or otherwise manage update data for the data processing system (e.g., 100A). For example, the other data requests may be provided to servers for applications installed and/or operation on data processing system 100A in order to obtain update data that may not be obtainable, for example, from device management system 104.

Following obtaining the data request at interaction 220, device management system 104 may perform data identification process 224. During data identification process 224, device management system 104 may identify data in response to the data request and generate a data package including the applicable data. For example, device management system 104 may identify data responsive to the data request in storage resources (e.g., storage device) of device management system and aggregate the responsive data (e.g., update data) in a data package to provide to management controller 152.

At interaction 226, the update data may be provided to management controller 152 by device management system 104 using the out-of-band communication channel (e.g., out-of-band channel 216). Although not explicitly shown in FIG. 2B, it is to be understood that transmission of data, requests, etc. to and/or from management controller 152 may go through network module 160 using out-of-band channel 216. More specifically, at interaction 226, device management system 104 may transmit the update data to network module 160 and network module 160 may provide the update data to management controller 152, for example, using the out-of-band communication channel (e.g., out-of-band channel 216).

Similarly, at interaction 228, other update data may be provided to management controller 152 by other external devices in response to the other data requests (e.g., described during interaction 222). The other update data may be provided to management controller 152 via network module 160. Although not explicitly shown in FIG. 2B, it is to be understood that transmission of data, requests, etc. to and/or from management controller 152 may go through network module 160 using out-of-band channel 216. More specifically, at interaction 228, other external devices may transmit the other update data to network module 160 and network module 160 may provide the other update data to management controller 152, for example, using the out-of-band communication channel (e.g., out-of-band channel 216).

Once received, data cache update process 230 may be performed to manage the data cached for data processing system 100A. During data cache update process 230, management controller 152 and hardware resources 150 may cooperatively manage the cached data using the update data (and/or other update data). For example, management controller 152 may provide instructions to a management controller agent hosted by hardware resources 150 to cache the updated data (e.g., the update data and/or the other update data obtained during interactions 222, 228, respectively) in a storage device hosted by hardware resources 150.

As part of performing data cache update process 230, previously cached update data may be managed by management controller 152 based on the applicable policies obtained during the processes and methods described above in FIG. 2A. For example, management controller 152 may identify a portion of previously cached update data that is not keyed to a potential destination location included in the potential destination locations of the applicable polices, and provide instructions to the management controller agent hosted by hardware resources 150 to discard (e.g., remove and/or delete) the identified portion of the previously cached update data.

As a result of performing data cache update process 230, the update data cached for data processing system 100A may be managed to comply with the applicable policies that will update operation of data processing system 100A based on the potential destination locations that the data processing system 100A may travel to in the future.

Turning to FIG. 2C, a third interaction diagram in accordance with an embodiment is shown. The third interaction diagram may illustrate processes and interactions that may occur during implementing an update workflow based on location data for a data processing system.

To implement the update workflow, at interaction 232, location data may be obtained and provided to management controller 152 by network module 160 using the out-of-band communication channel (e.g., out-of-band channel 216). More specifically, the location data may be generated by out-of-band components of the data processing system 100A, for example, using cell tower triangulation to obtain the location of the data processing system 100A even while some components (e.g., in-band components) of the data processing system 100A is not operating (e.g., powered off, lacking network connection, etc.).

Once obtained, the location data may be used to perform geolocation confirmation process 234. During geolocation confirmation process 234, management controller 152 may using the location data to generate inferences (e.g., using an inference model and/or other machine learning models) to identify a set of potential destination locations to which data processing system 100A is traveling. For example, management controller 152 may analyze the location data and historic location data (e.g., previously obtained location data for data processing system 100A) to generate a predicated location of which the data processing system is traveling to.

As part of performing geolocation confirmation process 234, management controller 152 may perform a filter process using the potential destination locations to identify whether any of the applicable policies may be triggered. For example, management controller 152 may use the set of potential destination locations (e.g., predicted destination locations) in a comparison process with the applicable policies to identify whether any of the criteria (e.g., trigger conditions such as locations) is met (e.g., determining whether any potential destination locations match the destination locations associated with the applicable policies). As a result of performing geolocation confirmation process 234, an update workflow may be selected for implementation to update operation of data processing system 100A.

Following geolocation confirmation process 234, system configuration process 236 may be performed to implement the updated workflow and obtain an updated data processing system 100A. During system configuration process 236, management controller 152 may cooperatively performing the update workflow with hardware resources 150 in order to update operation of data processing system 100A. For example, management controller 152 may provide instructions, using a side band communication channel (e.g., side band channel 214) to hardware resources 150 to implement the portion of the cached update data associated with the identified policy to modify the operation of hardware resources 150.

Following system configuration process 236 and at interaction 238, a notification may be generated and provided to cloud server 102 by management controller using the out-of-band communication channel. The notification may be provided to cloud server 102 via network module 160. Although not explicitly shown in FIG. 2C, it is to be understood that transmission of data, requests, etc. to and/or from management controller 152 may go through network module 160 using out-of-band channel 216. More specifically, at interaction 238, management controller 152 may transmit the notification to network module 160 and network module 160 may provide the notification to cloud server 102, for example, using the out-of-band communication channel (e.g., out-of-band channel 216).

The notification may be utilized by cloud server 102 to provide information regarding the applicable policies implemented by management controller 152 to update operation of data processing system 100A. In addition, the notification may provide information useable in the future to perform inferences and/or otherwise predict destination locations that data processing system 100A may travel to in the future.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures.

Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2C may perform various methods to update operations of data processing systems based on identifying policies associated with potential destination locations to which the data processing system is traveling using at least location data obtained via out-of-band communication methods. By utilizing location data, an out-of-band component of data processing systems may be able to implement policies corresponding to potential destinations of the data processing system prior to traveling to the potential destinations and in a timely manner and thereby, may decrease the likelihood of uninterrupted operation of data processing systems.

FIGS. 3A-3B illustrate methods that may be performed by the components of the system of FIGS. 1A-2C. In the diagrams discussed below and shown in FIGS. 3A-3B, any of the operations may be repeated, performed in different orders, and/or performed in parallel with or in a partially overlapping in time manner with other operations. The method described with respect to FIGS. 3A-3B may be performed by a data processing system, management controller, and/or by any other components of the system of FIGS. 1A-2C.

Turning to FIG. 3A, a flow diagram illustrating a method of managing operation of a data processing system in accordance with an embodiment is shown. The method may be performed, for example, by a data processing system, a management system, a communication system, a management controller, hardware resources, and/or other components illustrated in FIGS. 1A-2C.

At operation 300, location data for the data processing system may be obtained by a management controller and via an out-of-band communication channel using a resource of the data processing system. The location data may be obtained via (i) receiving the location data from an out-of-band component of the data processing system, (ii) reading the location data from storage, (iii) receiving the location data from another device, and/or (iv) by any other method.

At operation 302, a first set of potential destination locations to which the data processing system is traveling may be identified by the management controller and using at least the location data. The first set of potential destination locations may be identified via (i) analyzing the location data to identify potential destination locations, (ii) generating the potential destination locations by using, for example, an inference model, and/or (iii) by any other methods. For example, the potential destination locations may be generated using an inference model trained to infer potential destinations locations based on location data.

At operation 304, the first set of potential destination locations may be filtered by the management controller and using criteria to obtain filtered potential destination locations for the data processing system. The first set of potential destination locations may be filtered by comparing the first set of potential destination locations to the criteria to identify the potential destination locations that are more likely to result in the intended destination locations (e.g., final destination).

The criteria may be ascribed (e.g., specified) by a user and/or administrator of the data processing system and may specify different standards used to evaluate the proximity of the potential destination locations to identify useful and/or more relevant destination locations. For example, the criteria may specify distance limitations, straight-line distance estimations, and/or any other quantifiable basis for identifying potential destination locations that are useful and/or relevant to the user of the data processing system.

At operation 306, any policies that are keyed to any of the filtered potential destination locations may be identified by the management controller. The any of the policies may be identified by (i) performing a lookup process using the filtered potential destination locations (and/or portions of the potential destination locations) as a key for a potential destination location lookup table to identify one or more policies associated with (all of and/or any portions of) of the filtered potential destination locations, (ii) ingesting the filtered potential destination locations into an inference model (trained to identify policies associated with the filtered potential destination locations), and/or (iii) by any other methods.

At operation 308, a determination is made whether at least one policy of the any policies is keyed to at least one of the filtered potential destination locations. The determination may be based on the result from performing the identification process described in operation 306.

If it is determined that at least one policy of the any policies is keyed to at least one of the filtered potential destination locations (e.g., the determination is “Yes” at operation 308), then the method may proceed to operation 312 as discussed in FIG. 3B.

Returning to operation 308, if it is determined that the at least one policy of the any policies is not keyed to any of the filtered potential destination locations (e.g., the determination is “No” at operation 308), then the method may end following operation 308. For example, the filtered potential destination locations may not be keyed to any of the policies and therefore, operation of the data processing system may be maintained (e.g., the cached update data may not be used to modify operation of hardware resources of the data processing system).

The method may end following operation 308.

Turning to FIG. 3B, a flow diagram illustrating a method for managing operation of a data processing system in accordance with an embodiment is shown. The method may be performed, for example, by a data processing system, a management system, a communication system, a management controller, hardware resources, and/or other components illustrated in FIGS. 1A-2C.

Continuing the description of FIG. 3A, at operation 312, an update workflow may be selected by the management controller based on at least one policy. The update workflow may be selected via (i) identifying the update workflow that matches the at least one policy, (ii) obtaining instructions from the update workflow, and/or (iii) by any other methods. For example, identifying the update workflow may include performing a comparison process using the filtered potential destination locations and an applicable policies to identify whether the filtered potential destination locations match the destination locations keyed to the applicable policies.

At operation 314, the update workflow may be performed to obtain an updated data processing system. The update workflow may be performed by the management controller and using at least a sideband channel between the management controller and hardware resources of the data processing system. Performing the update workflow may include: using a portion of the cached update data associated with the at least one policy to modify operation of hardware resources of the data processing system, the hardware resources being distinct from the management controller, wherein a second portion of the cached update data is not associated with the at least one policy and is not used to modify the operation of the hardware resources.

For example, the update workflow may be performed by (i) identifying, by the management controller, the portion of the cached update data associated with the at least one policy, (ii) providing instructions to the hardware resources (via the side band channel) regarding implementation of the portion of the cached update data, (iii) reading, by the hardware resources, the instructions and the portion of the cached update data in order to modify operation of the hardware resources of the data processing system, and/or (iv) performing any other methods.

In order to obtain the cached update data, the method may also include: (i) obtaining, by the management controller and from a remote entity, the any policies, each of the any of the policies being based on a second set of potential destination locations to which the data processing system could travel in the future, (ii) obtaining, by the management controller, update data for the second set of potential destination locations, (iii) and caching, by the management controller, the update data for future use.

The policies may be obtained by (i) identifying, by the remote entity, the second set of potential destination locations, (ii) identifying any policies associated with potential destination locations included in the second set of potential destination locations, and/or (iii) performing any other methods.

The update data for the second set of potential destination locations may be obtained by (i) receiving the update data from a remote entity, (ii) reading the update data from storage, and/or (iii) performing any other methods. Receiving the update data from a remote entity may include: (i) performing, by the remote entity, a look up process using the second set of potential destination locations to obtain respectively associated update data included in a database that associates various potential destination locations with different update data, and (ii) receiving, by the management controller and from the remote entity, a message including the update data for the second set of potential destination locations.

The update data may be cached for future use by: (i) storing the update data in local storage (e.g., hosted by the management controller), (ii) providing instructions regarding storage of the update data to the hardware resources of the data processing system, and/or (iii) performing any other methods.

The method may also include: discarding, by the management controller, a portion of previously cached update data based on the second set of potential destination locations, the portion of the previously cached update data being keyed to a potential destination location that is not a member of the second set of potential destination locations. For example, the portion of the previously cached update data may be discarded by (i) comparing the potential destination location to the second set of potential destination locations to identify the potential destination location not included in the second set of potential destination locations, (ii) identifying the portion of the previously cached updated data based on the identified potential destination location not included in the second set of the potential destination locations, and/or (iii) deleting the portion of the previously cached update data from storage (e.g., of the management controller and/or of a storage device hosted by the data processing system).

At operation 316, computer implemented services may be provided to a user of the updated data processing system by using the updated data processing system. The computer implemented services may be provided via (i) ingesting, by the management controller, the updated data, (ii) performing the computer implemented services by the updated data processing system, and/or (iii) by performing any other methods.

The method may end following operation 316.

Using the methods illustrated in FIGS. 3A-3B, embodiments disclosed herein may provide systems and methods usable to manage operations of data processing systems by implementing policies corresponding to different potential destinations of the data processing system using out-of-band methods. By implementing applicable policies based on the potential destination locations, update data may be identified and operation of the data processing system may be updated based on the update data prior to the data processing system traveling to the potential destination. By updating operation of the data processing system prior to traveling to the potential destination location, computer implemented services that comply with geolocation based regulations and/or limitations specified by the applicable policies may be provided.

Any of the components illustrated in FIGS. 1A-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller of the data processing system and via an out-of-band communication channel, location data for the data processing system using a resource of the data processing system;
identifying, by the management controller and using at least the location data, a first set of potential destination locations to which the data processing system is traveling;
filtering, by the management controller and using criteria, the potential destination locations to obtain filtered potential destination locations for the data processing system;
identifying, by the management controller, any policies are keyed to any of the filtered potential destination locations;
in an instance of the identifying where at least one policy of the any policies is keyed to at least one of the filtered potential destination locations:
selecting, by the management controller, an update workflow based on the at least one policy;
performing, by the management controller and using at least a sideband channel between the management controller and hardware resources of the data processing system, the update workflow to obtain an updated data processing system; and
providing, using the updated data processing system, computer implemented services to a user of the updated data processing system.

2. The method of claim 1, further comprising:
obtaining, by the management controller and from a remote entity, the any policies, each of the any of the policies being based on a second set of potential destination locations to which the data processing system could travel in the future;
obtaining, by the management controller, update data for the second set of potential destination locations; and
caching, by the management controller, the update data for future use.

3. The method of claim 2, further comprising:
discarding, by the management controller, a portion of previously cached update data
based on the second set of potential destination locations, the portion of the previously cached update data being keyed to a potential destination location that is not a member of the second set of potential destination locations.

4. The method of claim 2, wherein the second set of potential destinations locations is based on indicators of future intent of travel for a user of the data processing system.

5. The method of claim 4, wherein the indicators of future intent comprise:
personal calendar items for the user regarding the travel for the user in the future; and
instant messages directed to and from the user expressing the intent of the travel.

6. The method of claim 5, wherein the indicators of the future intent do not include geolocation of the user, and geolocation of the data processing system.

7. The method of claim 2, wherein performing the update workflow comprises:
using a portion of the cached update data associated with the at least one policy to modify operation of hardware resources of the data processing system, the hardware resources being distinct from the management controller, wherein a second portion of the cached update data is not associated with the at least one policy and is not used to modify the operation of the hardware resources.

8. The method of claim 1, the data processing system comprises a network module adapted to separately advertise network endpoints for the management controller and the hardware resources of the data processing system, the network endpoints being usable by a server to address communications to the hardware resources using an in-band communication channel and the management controller using the out-of-band communication channel.

9. The method of claim 8, wherein the management controller and the network module are on separate power domains from the hardware resources so that the management controller and the network module are operable while the hardware resources are inoperable.

10. The method of claim 8, wherein the out-of-band communication channel runs through the network module, and the in-band communication channel that services the hardware resources also runs through the network module.

11. The method of claim 8, wherein the network module hosts a transmission control protocol/internet protocol (TCP/IP) stack to facilitate network communications via the out-of-band communication channel.

12. A non-transitory machine-readable medium having instructions stored therein, which when executed by a processor, cause the processor to perform operations for managing operation of a data processing system, the operations comprising:
obtaining, by a management controller of the data processing system and via an out-of-band communication channel, location data for the data processing system using a resource of the data processing system;
identifying, by the management controller and using at least the location data, a first set of potential destination locations to which the data processing system is traveling;
filtering, by the management controller and using criteria, the potential destination locations to obtain filtered potential destination locations for the data processing system;
identifying, by the management controller, any policies are keyed to any of the filtered potential destination locations;
in an instance of the identifying where at least one policy of the any policies is keyed to at least one of the filtered potential destination locations:
selecting, by the management controller, an update workflow based on the at least one policy;
performing, by the management controller and using at least a sideband channel between the management controller and hardware resources of the data processing system, the update workflow to obtain an updated data processing system; and
providing, using the updated data processing system, computer implemented services to a user of the updated data processing system.

13. The non-transitory machine-readable medium of claim 12, further comprising:
obtaining, by the management controller and from a remote entity, the any policies, each of the any of the policies being based on a second set of potential destination locations to which the data processing system could travel in the future;
obtaining, by the management controller, update data for the second set of potential destination locations; and
caching, by the management controller, the update data for future use.

14. The non-transitory machine-readable medium of claim 13, further comprising:
discarding, by the management controller, a portion of previously cached update data based on the second set of potential destination locations, the portion of the previously cached update data being keyed to a potential destination location that is not a member of the second set of potential destination locations.

15. The non-transitory machine-readable medium of claim 13, wherein the second set of potential destinations locations is based on indicators of future intent of travel for a user of the data processing system.

16. The non-transitory machine-readable medium of claim 15, wherein the indicators of future intent comprise:
personal calendar items for the user regarding the travel for the user in the future; and
instant messages directed to and from the user expressing the intent of the travel.

17. A data processing system, comprising:
a processor; and
a memory coupled to the processor to store instructions, which when executed by the processor, cause the processor to perform operations for managing operation of the data processing system, the operations comprising:
obtaining, by a management controller of the data processing system and via an out-of-band communication channel, location data for the data processing system using a resource of the data processing system;
identifying, by the management controller and using at least the location data, a first set of potential destination locations to which the data processing system is traveling;
filtering, by the management controller and using criteria, the potential destination locations to obtain filtered potential destination locations for the data processing system;
identifying, by the management controller, any policies are keyed to any of the filtered potential destination locations;
in an instance of the identifying where at least one policy of the any policies is keyed to at least one of the filtered potential destination locations:
selecting, by the management controller, an update workflow based on the at least one policy;
performing, by the management controller and using at least a sideband channel between the management controller and hardware resources of the data processing system, the update workflow to obtain an updated data processing system; and
providing, using the updated data processing system, computer implemented services to a user of the updated data processing system.

18. The data processing system of claim 17, further comprising:
obtaining, by the management controller and from a remote entity, the any policies, each of the any of the policies being based on a second set of potential destination locations to which the data processing system could travel in the future;
obtaining, by the management controller, update data for the second set of potential
destination locations; and
caching, by the management controller, the update data for future use.

19. The data processing system of claim 18, further comprising:
discarding, by the management controller, a portion of previously cached update data based on the second set of potential destination locations, the portion of the previously cached update data being keyed to a potential destination location that is not a member of the second set of potential destination locations.

20. The data processing system of claim 18, wherein the second set of potential destinations locations is based on indicators of future intent of travel for a user of the data processing system.
